(19) United States
(12) Patent Application Publication
(10) Pub. No.: US 2006/0019563 A1
(43) Pub. Date: Jan. 26, 2006

(54) "Barrier" substrate

(76) Inventor: Larry Rising, Kernersville, NC (US)

Correspondence Address: LARRY RISING, 3820 FIRESTONE RS, KERNERSVILLE, NC, 27284, US

(21) Appl. No.: 10/973,464

(22) Filed: Oct. 27, 2004

Related U.S. Application Data
(63) Continuation-in-part of application No. 10/896,854, filed on Jul. 23, 2004.

(51) Int. Cl. B32B 27/04; D04H 1/00; B32B 27/12

(52) U.S. Cl. 442/88; 442/327; 442/394; 442/149

(57) ABSTRACT

The present invention provides a multi-layered, lightweight “barrier” substrate with two (optionally anti-microbial and waterproof) fabrics or layers laminated together with a film providing both adhesion and a barrier. Various processes may make water repellant textile fabrics. The term “Barrier Substrate” as used herein means essentially impermeable to water, i.e. can support a considerable column of water without water penetration through the fabric. Such behavior is sometimes termed “water resistant.”The second layer providing the barrier can be either urethane (preferred), polyester or an acrylic material which can be a breathable, or non-breathable film which may be back coated after lamination or extrusion creating a third layer. Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the specification and claims.

### PRIORITY CLAIM

This application claims the benefit of priority to provisional application No. 60/486,668, filed in the United States on Jul. 12, 2003, and titled “Method and Apparatus to Create Laminated Barrier Substrates for Home Fabrics and Upholstery”.

### References Cited

U.S. Patent Documents

| | | | |
|---|---|---|---|
| 4525409 | June 1985 | Elesh. | |
| 4632860 | December 1986 | D'Antonio et al. | |
| 4772281 | September 1988 | Armstead | 604/358. |
| 5283112 | February 1994 | Krishnan. | |
| 5306536 | April 1994 | Moretz et al. | |
| 5391418 | February 1995 | Strongwater | 428/171. |
| 5514459 | May 1996 | Blauer et al. | |
| 5527600 | June 1996 | Frankosky et al. | |
| 5565265 | October 1996 | Rubin et al. | |
| 5631074 | May 1997 | Herlihy, Jr. | |
| 5677028 | October 1997 | Ravella | 428/102. |
| 5747392 | May 5, 1998 | Rubin | |

Foreign Patent Documents

| 0541206B1 | October 1999 | EP. |
|---|---|---|
| 1339859 | December 1973 | GB. |
| WO 80/01031 | May 1980 | WO. |
| 9729909 | August 1997 | WO. |

Other References Cites:
US Patent Publication No. US-2004-006827-A1, Dated Jan. 15, 2004
U.S. patent application Ser. No. 10/611,746, Dated Jun. 30, 2003

### BACKGROUND OF INVENTION

This application is in part a continuation of patent application Ser. No. 10/896,854, Filed Jul. 23, 2004, Titled “A Water and Stain

Repellent Barrier Substrate”.

There are several patents and publications on water and stain repellent textiles. The existing methods discussed in this application range from the application of wax coatings to polymeric films or multiple coatings of latex combined with polymeric films. Most of the existing technology would be better classified as repellent to stains and water and not be classified as a “barrier” substrate.

A waterproof and stain repellent “barrier” substrate as used herein means to support a column of water for several, minutes without water penetration through the fabric and not allow the absorption of stains or moisture by the fibers of the exposed surfaces as defined in this invention.

### DESCRIPTION OF THE RELATED ART

The related art of interest describes various waterproof fabrics for outdoor and Indoor use. None of the related art addresses the need for a light weigh low cost fabric type “barrier” substrate. The textile type “barrier” products are now produced by applying multiple coatings of acrylic and other copolymers to a substrate treated with fluorocarbons. The method requires multiple passes through very large energy consuming dryers that are polluting the environment. In addition to being very expensive the current method produces a very heavy and stiff product. By this invention a lightweight more durable product can be produced at half the energy now required thus allowing US textiles to compete world wide.

U.S. Pat. No. 5,283,112 issued on Feb. 1, 1994, to Sundaram Krishnan describes the making of waterproof breathable fabric laminates from polyurethane membrane bonded between woven or non-woven nylon fabric layers and the products useful for tenting and rainwear. The waterproof polyurethane added product is distinguishable for its emphasis on being breathable and mostly limited to breathable polyurethane compounds which would not be suitable for a barrier product as in this present invention.

U.S. Pat. No. 5,527,600 issued on Jun. 18, 1996, to Michael S. Frankosky et al. describes a bonded polyester fiberfill batting with a sealed outer surface by coating with an acrylic resin. The batting is useful for filling pillows, cushions, bedding materials, and in apparel. The batting is distinguishable for its non-laminated structure.

U.S. Pat. No. 5,565,265 issued on Oct. 15, 1996, to Craig A. Rubin et al. describes a liquid and stain resistant antimicrobial fabric made by repeatedly coating a polyester fabric in separate steps with an aqueous composition containing an acrylic copolymer, a fluorochemical and a biocide/mildewed. The antimicrobial agents disclosed are hereby incorporated by reference. The antimicrobial fabric is distinguishable for its limitation to a single substrate coated with multiple coatings and emphasis on polymeric films which would not be suitable for a barrier product as in this present invention.

U.S. Pat. No. 4,525,409 issued on Jun. 25, 1985, to James N. Elesh describes a tightly woven nylon or polyester treated fabric for producing bedding fabrics. The tightly woven taffeta or ripstop weave cloth is coated with urethane water repellant, a bacteriostatic and fungistatic agent, a fire retardant, and an anti-static agent. The antimicrobial compositions are incorporated by reference. The fabric is distinguishable by the addition of a plurality of agents to the single layer of the tightly woven fabric.

U.S. Pat. No. 4,632,860 issued on Dec. 30, 1986, to John P. D'Antonio et al. describes a waterproof, moisture-breathable, non-macerating, and hypoallergenic fabric by coating a substrate layer containing natural or synthetic fibers with a basecoat of an acrylic polymer and pigment, and a topcoat of either polyether urethane or silicone latex. The fabric is distinguishable for being a single coated layer.

U.S. Pat. No. 5,631,074 issued on May 20, 1997, to Daniel J. Herlihy, Jr. describes a two- or three-layer waterproof breathable fabric for outdoor athletic apparel comprising a shell fabric having a blend of polypropylene filaments and spandex fibers, a waterproof membrane of a copolyether ester laminated to the shell fabric, and

optionally, a crepe or mesh lining. A silicone coating may be applied on the shell fabric. The fabric is distinguishable for its waterproofing elastic quality used for a surfer dry suit and not be suitable for a barrier product as in the present invention.

U.S. Pat. No. 5,306,536 issued on Apr. 6, 1994, to Herbert L. Moretz et al. describes a multi-layer moisture management fabric comprising four layers for making undergarments for incontinent people. The shell fabric is conventional undergarment material, the second layer is a thick hydrophilic storage layer of nylon fibers, the third layer is a thin nylon transport layer, and the fourth innermost layer is a knitted or woven hydrophobic polyester layer. The third and fourth layers can be combined. The fabric is distinguishable for its lack of cohesiveness between layers as required in the present invention.

U.S. Pat. No. 5,514,459 issued on May 7, 1996, to Stephen J. Blauer et al. describes a waterproof breathable lining for outerwear comprising a shell fabric of a plain weave of nylon, acrylic or polyester which is printed with a pattern of a terpolymer containing 12-30% urethane, 1% silicone and the remainder being acrylic. The terpolymer pattern is impregnated with a fluorocarbon release agent. The lining includes an intermediate outer synthetic polymer membrane (polyurethane, polyester ether and/or polytetrafluoroethylene), an inner synthetic polymer fabric (nylon or polyester weave or knit), and optionally, an outer synthetic polymer fabric (nylon or polyester weave or knit). The four- or five-layer shell fabric and lining composition would not be suitable for a barrier product as in the present invention.

P.C.T. Patent Application No. WO 80/01031 published on May 15, 1980, for Frankosky describes a fiberfill blend for thermal insulation in garments comprising 70-90% crimped polyester staple fiber (polyethylene terephthalate) and 10-30% crimped staple binder fiber (ethylene terephthalate/ethylene isophthalate copolyester with 25-75 wt. % slickened with a cured polysiloxane. The fiberfill blend is distinguishable for its emphasis on thermal quality rather than waterproofing.

None of the above inventions and patents, taken either singularly or in combination, is seen to describe the present invention as claimed. Thus, a stain and waterproof “barrier” fabric which is light in weight, economical, fabric like and multi-ply is desired.

### SUMMARY OF THE INVENTION

The present invention relates to an improved waterproof barrier fabric useful for furniture, wall covering, and medical applications with optional antimicrobial properties.

It is a principal object of the invention to provide a stain and waterproof barrier substrate consisting of a layer laminated fabric. Top layer being a textile (woven or knit) substrate. Second layer being a film. The second layer provides the dual function of adhesive to top and bottom layers and provides the barrier. The third layer can be a non-woven substrate or a back coating of the second layer or left out completely creating a two layer laminate.

It is another object of the invention to provide a waterproof stain repellent fabric comprising a top layer of a material selected from the group consisting of man made fibers and natural fibers and mixtures thereof treated to be water and stain repellent with fluorocarbons as outline in U.S. Pat. No. 5,747,392 patent or U.S. patent application Ser. No 10/611,746, Dated Jun. 30, 2003.

In another aspect of the invention the third layer is an acrylic latex comprising a dispersion of polymers and/or copolymers of acrylic or acrylate functional monomers, optionally copolymerized with other ethylenically unsaturated monomers and back coated on to the second layer (being a film) after lamination process—creating a back coated laminate barrier substrate.

### DETAILED DESCRIPTION

The present invention relates generally to an improved 2 or 3-ply stain and waterproof barrier fabric useful for furniture upholstery, wall coverings, restaurant table coverings and medical applications. The layers can be laminated by being made to come in continuous contact, and while in contact, pressure is applied between a blanket and a roller. The pressure is about 50 lbs/in·sup·2 (34 N/cm·sup·2) to about 60 lbs/in·sup·2 (41 N/cm·sup·2), with 60 lbs/in·sup·2 (41 N/cm·sup·2) preferred. Heat is also applied at about 380.degree. F. to about 430. degree. F. (193. degree. C. to 221. degree. C.), preferably at 420. degree. F. (216. degree. C.). The dwell time, (15 to 30 sec.) or time where heat and/or pressure are applied, is a time sufficient for the film layer to become soft enough to provide bonding but not losing its ability to provide a barrier to liquid supporting a column of water.

The second layer a film layer can be supplied in roll stock film to the heat and pressure lamination process or be extruded into film via die slot and hot melt technology and applied directly to the back of the top substrate at the lamination process with or without release paper on one side. Those skilled in the art will know other methods to laminate the layers as there are any number of ways and the above is merely representative of two methods.

The third layer, a back coating, is dried and cured in an oven at approximately 250 degrees F. to 350 degrees F. The amount of the back coating can vary from a skim coating (0.001 to 0.005 inches thick) to 15 percent of fabric weight. Back coating as used herein is applying a coating to the back or bottom side of a substrate as oppose to placing it on the face or top of a substrate, when one side is different from the other. This type application can vary but most common is to use a doctor blade or knife-edge adjusted to touch or nearly touch the substrate surface as described in U.S. Pat. No. 5,747,392.

What is claimed is:

1. A waterproof and stain repellent fabric composition comprising of:
(a) a first top layer of a fabric selected from the group consisting of polyester, cotton, and polyester cotton blends treated with fluorocarbon formulas, being water or solvent based, to provide a water and stain repellent top layer. Example—as cited in U.S. Pat. No. 5,747,392 and US Patent Publication No. US-2004-0006827-A1.
(b) a second layer being an impervious film between the outer layer and the back layer providing an impervious barrier and also providing the adhesive or bonding of the top layer to the bottom layer when heat and pressure are properly applied as described in this application.
(c) a third layer being a back coating of latex or adhesive to the second layer.

2. The fabric composition according to claim 1, with first or top and/bottom or third or back layers having antimicrobial fibers.

3. The fabric composition according to claim 1, with first or top layer having polyester fibers and/or other man made fibers or blends of man made fibers.

4. The fabric composition according to claim 1, with first or top layer having greater than 40% cotton fibers and being bonded to said second layer by an adhesive.

5. The fabric composition according to claim 1, with first or top layer having a blend of polyester and cotton fibers or rayon and polyester blend or any combination of man made and natural fibers.

6. The fabric composition according to claim 1, with second layer being a urethane film at 0.001 to 0.003 inch thickness.

7. The fabric composition according to claim 1, with second layer being a urethane film with an adhesive webbing or adhesive coating added to increase bonding between top and second layer and/or between second and bottom layer.

8. The fabric composition according to claim 1, with second layer being a urethane film (roll goods) greater than 0.003 inch thickness.

9. The fabric composition according to claim 1, with second layer being a polyester film (roll goods) at 0.001 to 0.003 inch thickness.

10. The fabric composition according to claim 1, with second layer being a polyester film with an adhesive webbing or adhesive coating added to increase bonding between top and second layer and/or between second and bottom layer.

11. The fabric composition according to claim 1, with second layer being a polyester film (roll goods) greater than 0.003 inch thickness.

12. The fabric composition according to claim 1, with second layer being a layer of adheasive 0.001 inches thick to 0.03 inches thick extruded directly to the bottom of the top or first layer.

13. The fabric composition according to claim 1, with second layer providing an imperious barrier to prevent liquid from passing through the substrate.

14. The fabric composition according to claim 1, where second layer also servers the double duty as barrier and bonding adhesive for the top and back layers.

15. The fabric composition according to claim 1, wherein said third layer is polyester.

16. The fabric composition according to claim 1, wherein said third layer is an acrylic.

17. The fabric composition according to claim 1, wherein the third layer is an acrylic latex back coated on to the second layer (being a film) creating a back coated bi-laminate barrier substrate.

18. The fabric composition according to claim 1, wherein the third layer is a polyurethane latex back coated on to the second layer (being a film) creating a back coated bi-laminate barrier substrate.

19. The fabric composition according to claim 1, wherein the third layer is a copolymer latex back coated on to the second layer (being a film) creating a back coated bi-laminate barrier substrate.

20. The fabric composition according to claim 1, Wherein said third layer being treated with fluorocarbons to provide water and stain repellent backing.

21. A three layer back coated fabric composite where fabric comprising:
(a) a first outer layer of a woven or knit fabric;
(b) a second layer of a waterproof, film, one side of film being bonded to top layer and the other side being bonded to the third or bottom layer.
(c) a third layer being a substrate back coated after lamination of original three layers.

22. The fabric composition according to claim 21, Wherein said third layer being treated with fluorocarbons to provide water and stain repellent backing.
